(19) United States
(12) Patent Application Publication
(10) Pub. No.: US 2025/0277588 A1
(43) Pub. Date: Sep. 4, 2025

(54) COOKING APPLIANCE WITH AN AUXILIARY HEATING ELEMENT

(71) Applicant: WHIRLPOOL CORPORATION, BENTON HARBOR, MI (US)

(72) Inventors: Dick Ge, Shenzhen (CN); Benny Huang, Shenzhen (CN); Ryan Li, Shenzhen (CN)

(73) Assignee: WHIRLPOOL CORPORATION, BENTON HARBOR, MI (US)

(21) Appl. No.: 18/858,899

(22) PCT Filed: May 6, 2022
(86) PCT No.: PCT/CN2022/091167

§ 371 Date: Oct. 22, 2024

(51) Int. Cl. F24C 7/06; F24C 15/00

(52) U.S. Cl. CPC F24C 7/06; F24C 15/007

(57) ABSTRACT

A cooking appliance (10) includes a body (12) that defines a cooking cavity (14), a first electrical connection feature (16) coupled to the body (12), an auxiliary heating element (18), and a second electrical connection feature (20) coupled to the auxiliary heating element (18). The auxiliary heating element (18) is operable between a use position and a removed position. In the use position, the auxiliary heating element (18) is positioned within the cooking cavity (14). In the removed position, the auxiliary heating element (18) is positioned outside of the cooking cavity (14). The second electrical connection feature (20) is operable to move relative to the auxiliary heating element (18) between engaged and disengaged positions. Contact between the first electrical connection feature (16) and the second electrical connection feature (20) as the auxiliary heating element (18) enters the use position causes the second electrical connection feature (20) to enter the engaged position.

### BACKGROUND OF THE DISCLOSURE

The present disclosure generally relates to a cooking appliance and, more specifically, to a cooking appliance that includes an auxiliary heating element.

### SUMMARY OF THE DISCLOSURE

According to one aspect of the present disclosure, a cooking appliance includes a body that defines a cooking cavity, a first electrical connection feature coupled to the body, an auxiliary heating element, and a second electrical connection feature coupled to the auxiliary heating element. The auxiliary heating element is operable between a use position and a removed position. In the use position, the auxiliary heating element is positioned within the cooking cavity. In the removed position, the auxiliary heating element is positioned outside of the cooking cavity. The second electrical connection feature is operable to move relative to the auxiliary heating element between engaged and disengaged positions. Contact between the first electrical connection feature and the second electrical connection feature as the auxiliary heating element enters the use position causes the second electrical connection feature to enter the engaged position.

According to another aspect of the present disclosure, a cooking appliance includes a body that defines a cooking cavity, a first electrical connection feature coupled to the body, an auxiliary heating element, and a second electrical connection feature coupled to the auxiliary heating element. The auxiliary heating element is operable between a use position and a removed position. In the use position, the auxiliary heating element is positioned within the cooking cavity. In the removed position, the auxiliary heating element is positioned outside of the cooking cavity. The second electrical connection feature is operable to move relative to the auxiliary heating element between engaged and disengaged positions and biased toward the disengaged position. Contact between the first electrical connection feature and the second electrical connection feature as the auxiliary heating element enters the use position causes the second electrical connection feature to enter the engaged position. In the use position of the auxiliary heating element, a support feature of the body generally prevents forward movement of the auxiliary heating element, such that the auxiliary heating element is retained in the engaged position.

According to yet another aspect of the present disclosure, a cooking appliance includes a body that defines a cooking cavity and includes a support feature in communication with the cooking cavity, and an auxiliary heating element operable between a removed position and a use position. In the removed position, the auxiliary heating element is positioned outside of the cooking cavity. In the use position, the auxiliary heating element is positioned within the cooking cavity in contact with the support feature, such that forward movement of the auxiliary heating element out of the use position is generally prevented.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a cooking appliance that includes an auxiliary heating element in a use position;

FIG. 2 is a front elevational view of a cooking appliance that includes an auxiliary heating element in a removed position;

FIG. 3 is a cross-sectional plan view of an electrical connection feature of an auxiliary heating element of a cooking appliance in a disengaged position;

FIG. 4 is a cross-sectional plan view of an electrical connection feature of an auxiliary heating element of a cooking appliance in an engaged position, abutting a corresponding electrical connection feature of the cooking appliance; and

FIG. 5 is a cross-sectional view of a portion of the cooking appliance of FIG. 1 taken at line V-V and illustrating the auxiliary heating element in the use position.

The components in the figures are not necessarily to scale, emphasis instead being placed upon illustrating the principles described herein.

### DETAILED DESCRIPTION

The present illustrated embodiments reside primarily in combinations apparatus components related to a cooking appliance with an auxiliary heating element. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

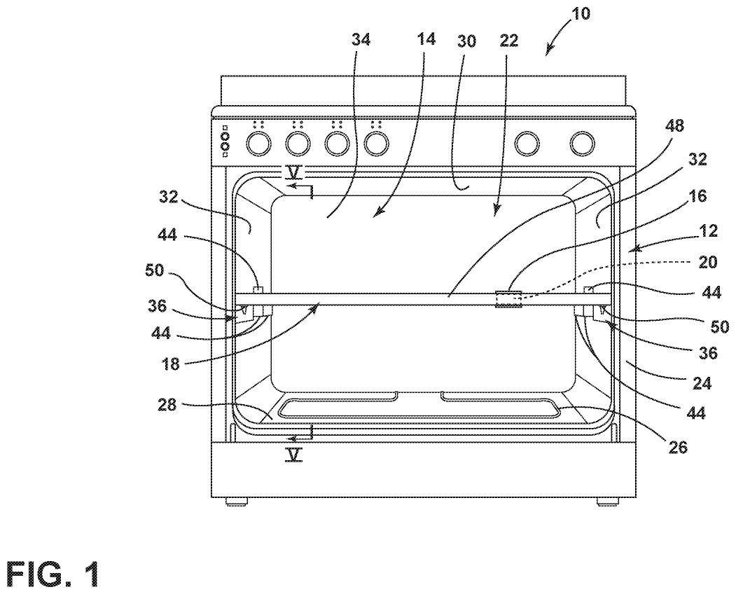

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. Further, the term “forward movement” and derivatives thereof shall refer to movement toward the intended viewer and perpendicular to the vertical direction and the left-right horizontal direction based on the disclosure as oriented in FIG. 1. The term “rearward movement” and derivatives thereof shall refer to movement away from the intended viewer and perpendicular to the vertical direction and the left-right horizontal direction based on the disclosure as oriented in FIG. 1. The term “downward movement” and derivatives thereof shall refer to movement from upper to lower in a direction perpendicular to the forward movement direction and the left-right horizontal direction based on the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring now to FIGS. 1-5, reference numeral 10 generally designates a cooking appliance. The cooking appliance 10 includes a body 12 that defines a cooking cavity 14. A first electrical connection feature 16 is coupled to the body 12. An auxiliary heating element 18 is operable between a use position, wherein the auxiliary heating element 18 is positioned within the cooking cavity 14, and a removed position, wherein the auxiliary heating element 18 is positioned outside of the cooking cavity 14. A second electrical connection feature 20 is coupled to the auxiliary heating element 18. The second electrical connection feature 20 is operable to move relative to the auxiliary heating element 18 between an engaged position and a disengaged position. Contact between the first electrical connection feature 16 and the second electrical connection feature 20 as the auxiliary heating element 18 enters the use position causes the second electrical connection feature 20 to enter the engaged position.

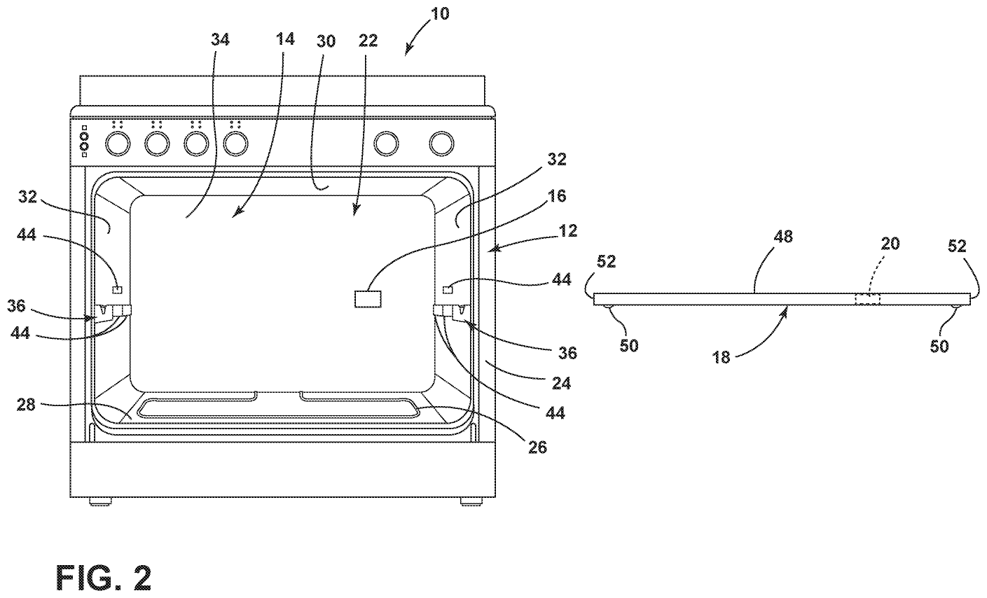

Referring now to FIGS. 1 and 2, the cooking appliance 10 includes the body 12. As illustrated in FIGS. 1 and 2, the body 12 defines a cooking cavity 14. The cooking cavity 14 is accessible via an opening 22 defined by the body 12 proximate to a front 24 of the cooking appliance 10. In various implementations, the cooking appliance 10 can include a door (not shown) that is configured to selectively cover the opening 22. The cooking cavity 14 is configured to receive food therein for cooking. The cooking appliance 10 can include at least one heating element 26 that is configured to produce heat for heating the cooking cavity 14. In various implementations, the heating element 26 may be an electrical heating element that is powered by electricity. A variety of types of heating elements 26 are contemplated. As illustrated in FIGS. 1 and 2, the heating element 26 is fixedly positioned within the cooking cavity 14 proximate to an interior bottom wall 28 of the body 12.

As further illustrated in FIGS. 1 and 2, the body 12 can include the interior bottom wall 28, an interior top wall 30 opposite the interior bottom wall 28, two interior side walls 32 that extend between the interior bottom and top walls 28, 30, and an interior rear wall 34 that is positioned opposite the opening 22 to the cooking cavity 14. The interior bottom, top, rear, and side walls 28, 30, 34, 32 define the cooking cavity 14, as illustrated in FIGS. 1 and 2. In various embodiments, the body 12 of the cooking appliance 10 is an assembly of a plurality of components.

Referring now to FIGS. 1, 2, and 5, the body 12 of the cooking appliance 10 includes a support feature 36. The support feature 36 is in communication with the cooking cavity 14. As described further herein, the support feature 36 is configured to support the auxiliary heating element 18 in the use position of the auxiliary heating element 18. In various implementations, the support feature 36 can be positioned on the interior side wall 32 of the body 12 of the cooking appliance 10. As illustrated in FIGS. 1, 2, and 5, the body 12 of the cooking appliance 10 can include a plurality of support features 36, in some implementations. As illustrated in FIGS. 1 and 2, both interior side walls 32 of the body 12 include respective support features 36. Further, as illustrated in FIG. 4, the interior side wall 32 includes two support features 36 that are vertically aligned and in a spaced relationship with each other. In the illustrated embodiment, the support feature 36 extends outward from the adjacent portion of the interior side wall 32 into the cooking cavity 14.

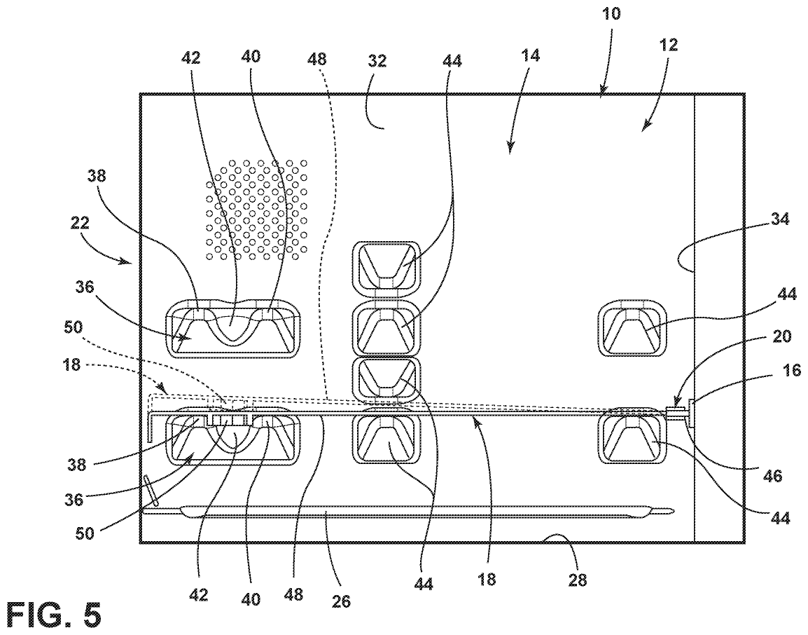

In the embodiment illustrated in FIG. 5, the support feature 36 is positioned on the interior side wall 32 of the body 12 and includes a first shelf portion 38, a second shelf portion 40, and a saddle portion 42. The second shelf portion 40 is positioned between the first shelf portion 38 and the interior rear wall 34 of the body 12. The saddle portion 42 extends between the first shelf portion 38 and the second shelf portion 40. As illustrated in FIG. 5, the saddle portion 42 extends vertically downward and toward the interior side wall 32 that the support feature 36 is positioned on from both the first shelf portion 38 and the second shelf portion 40.

Referring still to FIG. 5, in various implementations, the body 12 of the cooking appliance 10 can include a protrusion 44. In various embodiments, the body 12 of the cooking appliance 10 includes a plurality of protrusions 44. The protrusion 44 of the body 12 is in communication with the cooking cavity 14 and extends outward from at least one of the interior rear wall 34 and the interior side wall 32 of the body 12. For example, in the embodiment illustrated in FIG. 5, the body 12 includes a plurality of protrusions 44 that extend outward from the interior side wall 32 into the cooking cavity 14. As illustrated, each of the protrusions 44 are positioned generally between the interior rear wall 34 and the support feature 36. In other words, the protrusions 44 are positioned rearward of the support feature 36. As described further herein, the protrusions 44 may cooperate with the support feature 36 to guide movement of the auxiliary heating element 18 into and out of the use position, and support the auxiliary heating element 18 in the use position.

Referring now to FIGS. 1-5, the cooking appliance 10 includes the first electrical connection feature 16. The first electrical connection feature 16 is coupled to the body 12 of the cooking appliance 10. In various implementations, the first electrical connection feature 16 is in communication with the cooking cavity 14 defined by the body 12 of the cooking appliance 10. For example, as illustrated in FIG. 2, the first electrical connection feature 16 is disposed on the interior rear wall 34 of the body 12. It is contemplated that the first electrical connection feature 16 may be positioned on various portions of the body 12 that are in communication with the cooking cavity 14 (e.g., interior side wall 32, etc.). As described further herein, the first electrical connection feature 16 may be operable to contact the second electrical connection feature 20 to provide electricity to the auxiliary heating element 18.

Referring now to FIGS. 1 and 2, the cooking appliance 10 includes the auxiliary heating element 18. The auxiliary heating element 18 may be selectively coupled to the body 12 within the cooking cavity 14. In other words, the auxiliary heating element 18 may be intended to be removed from the cooking cavity 14. As illustrated in FIGS. 1 and 2, the auxiliary heating element 18 is operable between the use position (FIG. 1), wherein the auxiliary heating element 18 is positioned within the cooking cavity 14, and the removed position (FIG. 2), wherein the auxiliary heating element 18 is positioned outside of the cooking cavity 14.

Referring now to FIGS. 1-5, the second electrical connection feature 20 is coupled to the auxiliary heating element 18. The second electrical connection feature 20 is configured to contact the first electrical connection feature 16 in the use position of the auxiliary heating element 18. In some implementations, the second electrical connection feature 20 is operable to move relative to the auxiliary heating element 18 between the engaged position and the disengaged position. Contact between the first electrical connection feature 16 and the second electrical connection feature 20, as the auxiliary heating element 18 enters the use position, can cause the second electrical connection feature 20 to enter the engaged position. In some implementations, the second electrical connection feature 20 is biased toward the disengaged position. In some embodiments, the second electrical connection feature 20 moves toward the auxiliary heating element 18 from the disengaged position to the engaged position.

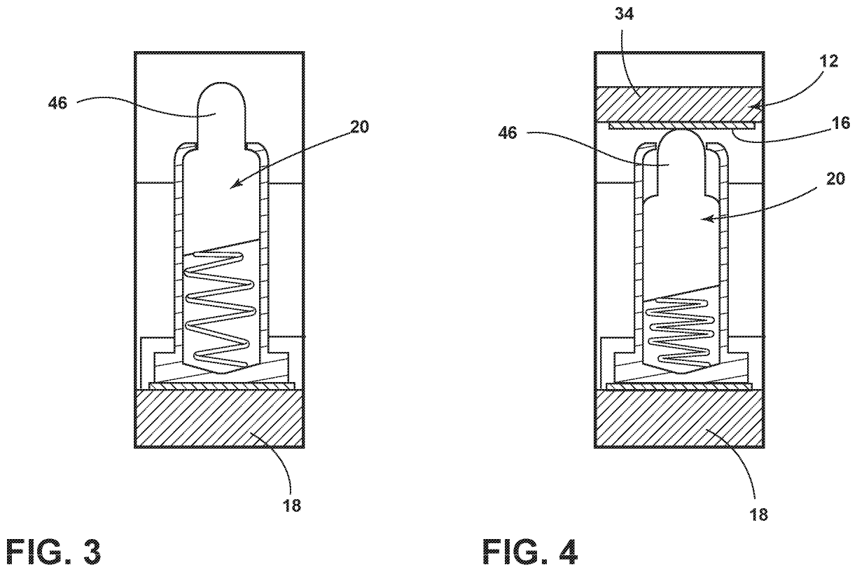

A variety of types of electrical connection features are contemplated. For example, the second electrical connection feature 20 can be magnetic and mutually correspond with a magnetic first electrical connection feature 16. In the embodiment illustrated in FIGS. 3 and 4, the second electrical connection feature 20 is a pogo pin 46. The pogo pin 46 is coupled to the auxiliary heating element 18 and is operable to be depressed from the disengaged position, as illustrated in FIG. 3, to the engaged position, as illustrated in FIG. 4, due to contact between the pogo pin 46 and the first electrical connection feature 16 as the auxiliary heating element 18 is moved from the removed position to the use position. In the engaged position of the second electrical connection feature 20, electricity is supplied to the auxiliary heating element 18 via the connection between the first and second electrical connection features 16, 20. As illustrated in FIGS. 3 and 4, the pogo pin 46 moves toward the auxiliary heating element 18 from the disengaged position to the engaged position.

Referring now to FIGS. 1, 2, and 5, the auxiliary heating element 18 can include a panel portion 48 and a stop feature 50 that is coupled to the panel portion 48. As illustrated in FIG. 2, the stop feature 50 may extend generally downward from the panel portion 48 and may be positioned proximate to a lateral side 52 of the panel portion 48. In various implementations, the panel portion 48 and/or the stop feature 50 can be configured to contact the support feature 36 and/or one or more protrusions 44, as described further herein.

Referring now to FIGS. 1 and 5, in various implementations, the support feature 36 of the body 12 is configured to support the auxiliary heating element 18 in the use position of the auxiliary heating element 18. In some embodiments, the support feature 36 contacts the auxiliary heating element 18 in the use position of the auxiliary heating element 18, such that the support feature 36 generally prevents forward movement of the auxiliary heating element 18 out of the use position. In some implementations, the support feature 36 contacts the auxiliary heating element 18 in the use position of the auxiliary heating element 18, such that the support feature 36 generally prevents downward movement of the auxiliary heating element 18 within the cooking cavity 14.

Referring now to FIGS. 1, 2, and 5, in some implementations, wherein the auxiliary heating element 18 includes the panel portion 48 and the stop feature 50 coupled to the panel portion 48, contact between the support feature 36 and the stop feature 50 of the auxiliary heating element 18 can generally prevent forward movement of the auxiliary heating element 18 out of the use position. As illustrated in FIG. 5, the support feature 36 is positioned on the interior side wall 32 and includes the first shelf portion 38, the second shelf portion 40, and the saddle portion 42 extending between the first and second shelf portions 38, 40. In the illustrated embodiment, the stop feature 50 of the auxiliary heating element 18 contacts the saddle portion 42 proximate to the first shelf portion 38 in the use position of the auxiliary heating element 18, such that the saddle portion 42 generally prevents forward movement of the auxiliary heating element 18 out of the use position. As further illustrated in FIG. 5, the panel portion 48 of the auxiliary heating element 18 rests upon the first and second shelf portions 38, 40, such that the first and second shelf portions 38, 40 generally prevent downward movement of the auxiliary heating element 18 within the cooking cavity 14 in the use position of the auxiliary heating element 18.

In the embodiment illustrated in FIG. 5, the second electrical connection feature 20 includes the pogo pin 46, which is contacting the first electrical connection feature 16 in the engaged position with the auxiliary heating element 18 in the use position. The pogo pin 46 is biased toward the interior rear wall 34 of the body 12. Accordingly, the support feature 36 generally preventing forward movement of the auxiliary heating element 18 out of the use position generally prevents the pogo pin 46 from moving with its biasing force from the engaged position to the disengaged position. It is contemplated that the second electrical connection feature 20 may be biased toward the disengaged position in a direction that is opposite the direction that the support feature 36 generally prevents the auxiliary heating element 18 from moving out of the use position. Various directions are contemplated.

As illustrated in FIG. 5, the auxiliary heating element 18 is operable to pivot upward to a position in which the support feature 36 does not prevent forward movement of the auxiliary heating element 18. The protrusion 44 nearest to the interior rear wall 34 of the body 12 acts as a fulcrum for the pivotal movement of the auxiliary heating element 18 (shown in phantom).

In operation of an exemplary embodiment of the cooking appliance 10, a user, desiring to supplement the permanent heating element 26 within the cooking cavity 14 of the cooking appliance 10, moves the auxiliary heating element 18 from the removed position to the use position. In the use position, the second electrical connection feature 20 coupled to the auxiliary heating element 18 contacts the first electrical connection feature 16, such that the second electrical connection feature 20 is maintained in the engaged position. The support feature 36 of the body 12 of the cooking appliance 10 supports the auxiliary heating element 18 and generally prevents forward movement of the auxiliary heating element 18 out of the use position. Upon desiring to remove the auxiliary heating element 18 from the use position, the user tilts the forward end of the auxiliary heating element 18 upward, using the protrusion 44 extending outward from the interior side wall 32 of the body 12 as a fulcrum until the support feature 36 no longer prevents forward movement of the auxiliary heating element 18 out of the use position. The user then slides the auxiliary heating element 18 out of the cooking cavity 14 to the removed position.

According to an aspect of the present disclosure, a cooking appliance includes a body that defines a cooking cavity, a first electrical connection feature coupled to the body, an auxiliary heating element, and a second electrical connection feature coupled to the auxiliary heating element. The auxiliary heating element is operable between a use position and a removed position. In the use position, the auxiliary heating element is positioned within the cooking cavity. In the removed position, the auxiliary heating element is positioned outside of the cooking cavity. The second electrical connection feature is operable to move relative to the auxiliary heating element between engaged and disengaged positions. Contact between the first electrical connection feature and the second electrical connection feature as the auxiliary heating element enters the use position causes the second electrical connection feature to enter the engaged position.

According to another aspect of the present disclosure, the second electrical connection feature is biased toward the disengaged position.

According to another aspect of the present disclosure, the second electrical connection feature moves toward the auxiliary heating element from the disengaged position to the engaged position.

According to another aspect of the present disclosure, the second electrical connection feature includes a pogo pin.

According to another aspect of the present disclosure, the body includes a support feature in communication with the cooking cavity and configured to support the auxiliary heating element in the use position of the auxiliary heating element.

According to another aspect of the present disclosure, the support feature contacts the auxiliary heating element in the use position of the auxiliary heating element, such that the support feature generally prevents forward movement of the auxiliary heating element out of the use position.

According to another aspect of the present disclosure, the support feature contacts the auxiliary heating element in the use position of the auxiliary heating element, such that the support feature generally prevents downward movement of the auxiliary heating element within the cooking cavity.

According to another aspect of the present disclosure, the auxiliary heating element includes a panel portion and a stop feature that is coupled to the panel portion, wherein contact between the support feature and the stop feature generally prevents forward movement of the auxiliary heating element out of the use position.

According to another aspect of the present disclosure, the support feature is positioned on an interior side wall of the body and includes a first shelf portion, a second shelf portion between the first shelf portion and an interior rear wall of the body, and a saddle portion extending between the first and second shelf portions.

According to another aspect of the present disclosure, the stop feature contacts the saddle portion proximate to the first shelf portion in the use position, such that the saddle portion generally prevents forward movement of the auxiliary heating element out of the use position.

According to yet another aspect of the present disclosure, the panel portion rests upon the first and second shelf portions, such that the first and second shelf portions generally prevent downward movement of the auxiliary heating element within the cooking cavity in the use position of the auxiliary heating element.

According to another aspect of the present disclosure, a cooking appliance includes a body that defines a cooking cavity, a first electrical connection feature coupled to the body, an auxiliary heating element, and a second electrical connection feature coupled to the auxiliary heating element. The auxiliary heating element is operable between a use position and a removed position. In the use position, the auxiliary heating element is positioned within the cooking cavity. In the removed position, the auxiliary heating element is positioned outside of the cooking cavity. The second electrical connection feature is operable to move relative to the auxiliary heating element between engaged and disengaged positions and biased toward the disengaged position. Contact between the first electrical connection feature and the second electrical connection feature as the auxiliary heating element enters the use position causes the second electrical connection feature to enter the engaged position. In the use position of the auxiliary heating element, a support feature of the body generally prevents forward movement of the auxiliary heating element, such that the auxiliary heating element is retained in the engaged position.

According to another aspect of the present disclosure, the second electrical connection feature moves toward the auxiliary heating element from the disengaged position to the engaged position.

According to another aspect of the present disclosure, the second electrical connection feature includes a pogo pin.

According to another aspect of the present disclosure, the support feature contacts the auxiliary heating element in the use position of the auxiliary heating element, such that the support feature generally prevents downward movement of the auxiliary heating element within the cooking cavity.

According to another aspect of the present disclosure, the auxiliary heating element includes a panel portion and a stop feature that is coupled to the panel portion, wherein contact between the support feature and the stop feature generally prevents forward movement of the auxiliary heating element out of the use position.

According to another aspect of the present disclosure, the support feature is positioned on an interior side wall of the body and includes a first shelf portion, a second shelf portion between the first shelf portion and an interior rear wall of the body, and a saddle portion extending between the first and second shelf portions.

According to another aspect of the present disclosure, the stop feature contacts the saddle portion proximate to the first shelf portion in the use position, such that the saddle portion generally prevents forward movement of the auxiliary heating element out of the use position.

According to yet another aspect of the present disclosure, the panel portion rests upon the first and second shelf portions, such that the first and second shelf portions generally prevent downward movement of the auxiliary heating element within the cooking cavity in the use position of the auxiliary heating element.

According to yet another aspect of the present disclosure, a cooking appliance includes a body that defines a cooking cavity and includes a support feature in communication with the cooking cavity, and an auxiliary heating element operable between a removed position and a use position. In the removed position, the auxiliary heating element is positioned outside of the cooking cavity. In the use position, the auxiliary heating element is positioned within the cooking cavity in contact with the support feature, such that forward movement of the auxiliary heating element out of the use position is generally prevented.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooking appliance, comprising:
a body that defines a cooking cavity;
a first electrical connection feature coupled to the body;
an auxiliary heating element operable between a use position, wherein the auxiliary heating element is positioned within the cooking cavity, and a removed position, wherein the auxiliary heating element is positioned outside of the cooking cavity; and
a second electrical connection feature coupled to the auxiliary heating element and operable to move relative to the auxiliary heating element between engaged and disengaged positions, wherein contact between the first electrical connection feature and the second electrical connection feature as the auxiliary heating element enters the use position causes the second electrical connection feature to enter the engaged position.

2. The cooking appliance of claim 1, wherein the second electrical connection feature is biased toward the disengaged position.

3. The cooking appliance of claim 1, wherein the second electrical connection feature moves toward the auxiliary heating element from the disengaged position to the engaged position.

4. The cooking appliance of claim 1, wherein the second electrical connection feature includes a pogo pin.

5. The cooking appliance of claim 1, wherein the body comprises:
a support feature in communication with the cooking cavity and configured to support the auxiliary heating element in the use position of the auxiliary heating element.

6. The cooking appliance of claim 5, wherein the support feature contacts the auxiliary heating element in the use position of the auxiliary heating element, such that the support feature generally prevents forward movement of the auxiliary heating element out of the use position.

7. The cooking appliance of claim 6, wherein the support feature contacts the auxiliary heating element in the use position of the auxiliary heating element, such that the support feature generally prevents downward movement of the auxiliary heating element within the cooking cavity.

8. The cooking appliance of claim 7, wherein the auxiliary heating element includes a panel portion and a stop feature that is coupled to the panel portion, wherein contact between the support feature and the stop feature generally prevents forward movement of the auxiliary heating element out of the use position.

9. The cooking appliance of claim 8, wherein the support feature is positioned on an interior side wall of the body and comprises:
a first shelf portion;
a second shelf portion between the first shelf portion and an interior rear wall of the body; and
a saddle portion extending between the first and second shelf portions.

10. The cooking appliance of claim 9, wherein the stop feature contacts the saddle portion proximate to the first shelf portion in the use position, such that the saddle portion generally prevents forward movement of the auxiliary heating element out of the use position.

11. The cooking appliance of claim 10, wherein the panel portion rests upon the first and second shelf portions, such that the first and second shelf portions generally prevent downward movement of the auxiliary heating element within the cooking cavity in the use position of the auxiliary heating element.

12. A cooking appliance, comprising:
a body that defines a cooking cavity;
a first electrical connection feature coupled to the body;
an auxiliary heating element operable between a use position, wherein the auxiliary heating element is positioned within the cooking cavity, and a removed position, wherein the auxiliary heating element is positioned outside of the cooking cavity; and
a second electrical connection feature coupled to the auxiliary heating element and operable to move relative to the auxiliary heating element between engaged and disengaged positions and biased toward the disengaged position, wherein contact between the first electrical connection feature and the second electrical connection feature as the auxiliary heating element enters the use position causes the second electrical connection feature to enter the engaged position, and wherein, in the use position of the auxiliary heating element, a support feature of the body generally prevents forward movement of the auxiliary heating element, such that the auxiliary heating element is retained in the engaged position.

13. The cooking appliance of claim 12, wherein the second electrical connection feature moves toward the auxiliary heating element from the disengaged position to the engaged position.

14. The cooking appliance of claim 12, wherein the second electrical connection feature includes a pogo pin.

15. The cooking appliance of claim 12, wherein the support feature contacts the auxiliary heating element in the use position of the auxiliary heating element, such that the support feature generally prevents downward movement of the auxiliary heating element within the cooking cavity.

16. The cooking appliance of claim 15, wherein the auxiliary heating element includes a panel portion and a stop feature that is coupled to the panel portion, wherein contact between the support feature and the stop feature generally prevents forward movement of the auxiliary heating element out of the use position.

17. The cooking appliance of claim 16, wherein the support feature is positioned on an interior side wall of the body and comprises:
a first shelf portion;
a second shelf portion between the first shelf portion and an interior rear wall of the body; and
a saddle portion extending between the first and second shelf portions.

18. The cooking appliance of claim 17, wherein the stop feature contacts the saddle portion proximate to the first shelf portion in the use position, such that the saddle portion generally prevents forward movement of the auxiliary heating element out of the use position.

19. The cooking appliance of claim 18, wherein the panel portion rests upon the first and second shelf portions, such that the first and second shelf portions generally prevent downward movement of the auxiliary heating element within the cooking cavity in the use position of the auxiliary heating element.

20. A cooking appliance, comprising:
a body that defines a cooking cavity and includes a support feature in communication with the cooking cavity; and
an auxiliary heating element operable between a removed position, wherein the auxiliary heating element is positioned outside of the cooking cavity, and a use position, wherein the auxiliary heating element is positioned within the cooking cavity in contact with the support feature, such that forward movement of the auxiliary heating element out of the use position is generally prevented.
